(19) United States
(12) Patent Application Publication
(10) Pub. No.: US 2024/0092089 A1
(43) Pub. Date: Mar. 21, 2024

(54) PRINTER DEVICE

(71) Applicant: TOSHIBA TEC KABUSHIKI KAISHA, Tokyo (JP)

(72) Inventor: Keisuke Takahashi, Izunokuni Shizuoka (JP)

(21) Appl. No.: 18/450,438

(22) Filed: Aug. 16, 2023

Related U.S. Application Data
(62) Division of application No. 17/947,197, filed on Sep. 19, 2022.

(51) Int. Cl. B41J 3/407; B41J 11/00; B41J 11/66

(52) U.S. Cl. CPC B41J 3/4075; B41J 11/0095; B41J 11/663

(57) ABSTRACT

A printer including a conveyance unit to convey long label paper in which a plurality of label areas each of which corresponds to one label and are disposed in one direction and a wireless tag is attached to each of the label areas, a printing unit to perform printing on the label paper, a cutting unit disposed at a rear stage of the printing unit to cut the label paper, a writing unit disposed at a rear stage of the cutting unit to perform writing of data on the wireless tag, and a processor, in which the processor allows printing by the printing unit to be performed and writing of data by the writing unit to be performed on the label area positioned at a front end of the label paper while controlling the conveyance unit to convey the label paper between the printing unit and the writing unit and allows the label area to be cut by the cutting unit, thereby issuing a label.

### CROSS-REFERENCE TO RELATED APPLICATION

This application is a Divisional of application Ser. No. 17/947,197 filed on Sep. 19, 2022, the entire contents of which are incorporated herein by reference.

### FIELD

Embodiments described herein relate generally to a printer device.

### BACKGROUND

Conventionally, there is a printer device that issues a leaf-shaped label by conveying long paper in a forward direction, performing printing on areas (hereinafter also referred to as label areas) corresponding to one label by a printing unit at a front stage and cutting the printed label area by a cutting unit at a rear stage.

Further, conventionally, there is label paper provided with a wireless tag such as a radio frequency identification (RFID) tag in each of the label areas. Furthermore, there is a printer device capable of performing writing of data on the wireless tag. For example, there is a printer device in which a writing unit capable of performing writing to the wireless tag is provided in a front stage of the printing unit and writing of data to the wireless tag provided in the label area is performed prior to printing by the printing unit.

By the way, in the printer device described above, after the issuance of one label is completed, backfeed for conveying the label paper in a reverse direction needs to be performed in order to prepare for the issuance of a next label.

However, in a configuration in which a writing unit for the wireless tag is provided in the front stage of the printing unit, the label paper is backfed to a position of the writing unit beyond the printing unit, and thus a front end part of the label paper is temporarily deviated from a conveyance path leading to the printing unit. In this case, in the conventional configuration, there is a possibility that problems such as deviation of the label paper from the conveyance path or deviation of a printing position may occur if the conveyance in the forward direction is resumed.

### DESCRIPTION OF THE DRAWINGS

FIG. 1 is a diagram illustrating a schematic configuration of a label printer according to an embodiment;

FIG. 2 is a diagram schematically illustrating an example of label paper;

FIG. 3 is a diagram illustrating an example of a hardware configuration of the label printer;

FIG. 4 is a diagram illustrating an example of a functional configuration of the label printer;

FIG. 5 is a flow chart illustrating an example of a label issuance process executed by the label printer;

FIG. 6 is a diagram for describing a label issuance operation of the label printer;

FIG. 7 is a diagram for describing another label issuance operation of the label printer;

FIG. 8 is a diagram for describing another label issuance operation of the label printer;

FIG. 9 is a diagram for describing another label issuance operation of the label printer;

FIG. 10 is a diagram for describing another label issuance operation of the label printer;

FIG. 11 is a flowchart illustrating an example of a label issuance process executed by a label printer of Modification 1;

FIG. 12 is a diagram for describing a label issuance operation of the label printer according to Modification 1;

FIG. 13 is a flowchart illustrating an example of a label issuance process executed by a label printer of Modification 2; and

FIG. 14 is a diagram for describing a label issuance operation of the label printer according to Modification 2.

### DETAILED DESCRIPTION

In general, according to one embodiment, there is provided a printer device including a conveyance unit configured to convey long label paper in which a plurality of label areas each of which corresponds to one label and are disposed in one direction and a wireless tag is attached to each of the label areas, a printing unit configured to perform printing on the label paper, a cutting unit disposed at a rear stage of the printing unit and configured to cut the label paper, a writing unit disposed at a rear stage of the cutting unit and configured to perform writing of data on the wireless tag, and a processor, in which the processor is configured to allow printing by the printing unit to be performed and writing of data by the writing unit to be performed on the label area positioned at a front end of the label paper while controlling the conveyance unit to convey the label paper between the printing unit and the writing unit and allow the label area to be cut by the cutting unit, thereby issuing a label.

Hereinafter, embodiments will be described in detail with reference to the drawings. An exemplary embodiment is not limited by the embodiments described below.

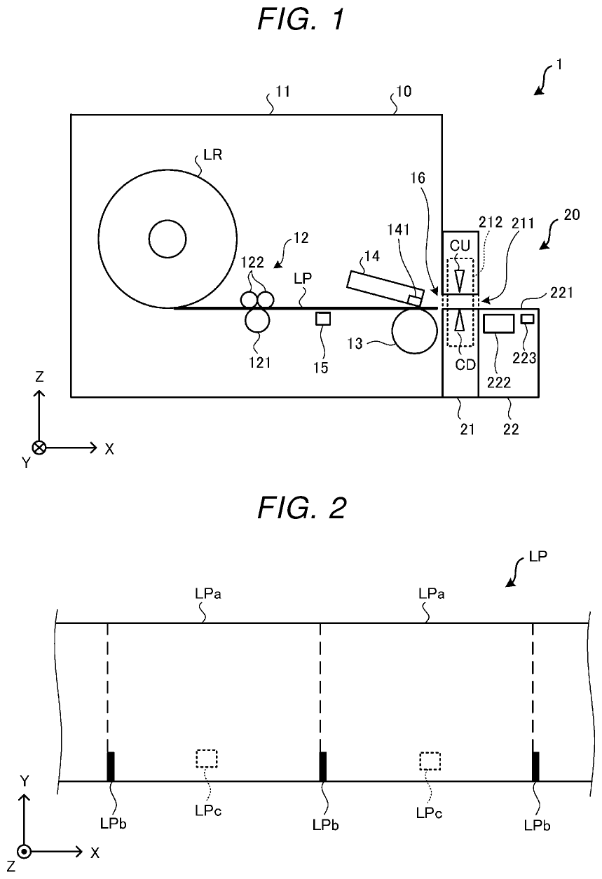

FIG. 1 is a diagram illustrating a schematic configuration of a label printer 1 according to an embodiment. The label printer 1 is an example of a printer device in the exemplary embodiment. The X, Y, and Z-axes shown in the drawings indicate a width direction (X-direction), a depth direction (Y-direction), and a height direction (Z-direction) if the label printer 1 is viewed from one side.

The label printer 1 includes a printer unit 10 and a post-processing unit 20. The printer unit 10 includes, for example, a box-shaped housing 11, and a label roll LR is contained inside the housing 11. The label roll LR is a roll formed by winding label paper LP, which is an example of paper, in a roll shape.

FIG. 2 is a diagram schematically illustrating an example of the label paper LP. As illustrated in FIG. 2, the label paper LP is a long paper on which label areas LPa each of which corresponds to one label and are disposed in one direction. The label paper LP may be, for example, sticker paper coated with an adhesive such as glue on a back surface side of a surface (hereinafter also referred to as a front surface) on which printing is performed. In this case, the label paper LP may be a long release paper (also referred to as mount or liner) on which the sticker paper that serves as a label is pasted, or may be one without the release paper.

The label paper LP includes a plurality of label areas LPa. The label paper LP can also be defined as paper in which the plurality of label areas LPa are continuously disposed at predetermined intervals. In FIG. 2, the label area LPa is represented by a broken line, but the broken line is provided for convenience of explanation and may not be displayed.

The label paper LP is provided with a detection mark LPb at a boundary portion of the label area LPa. The detection mark LPb is, for example, a black mark, and is used when detecting a front end (or rear end) of the label area LPa. If a printing surface of the label paper LP is the front surface, the detection mark LPb may be provided on a back surface side or a front surface side of the label paper LP. If the label paper LP is a long release paper with labels attached, a gap between the labels can be detected from an amount of light transmitted through the label paper LP, and thus the detection mark LPb may not be needed.

The label paper LP includes a wireless tag LPc such as an RFID tag in each of the label areas LPa. A method of attaching the wireless tag LPc to the label paper LP is not particularly limited, and various methods can be adopted. For example, the wireless tag LPc may be attached to the front surface side or back surface side of the label paper LP, or may be embedded in the inside of the label paper LP.

Referring back to FIG. 1, the printer unit 10 includes a conveyance roller 12, a platen roller 13, a printing unit 14, and a first sensor unit 15 inside the housing 11.

The conveyance roller 12 includes, for example, a capstan roller 121 and an auxiliary roller 122. The label paper LP pulled out from the label roll LR is inserted through between the capstan roller 121 and the auxiliary roller 122. The platen roller 13 is disposed at a position facing the printing unit 14. The label paper LP is inserted through between the platen roller 13 and the printing unit 14.

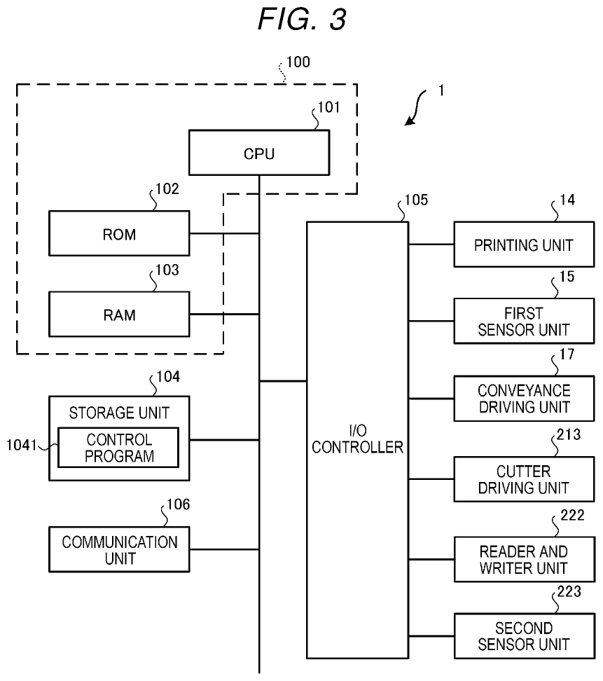

The capstan roller 121 and the platen roller 13 are rotationally driven by a conveyance driving unit 17 (see FIG. 3). For example, the conveyance driving unit 17 rotates the capstan roller 121 and the platen roller 13 clockwise to convey the label paper LP toward a discharge port 16 in a forward direction (+X-direction). For example, the conveyance driving unit 17 rotates the capstan roller 121 and the platen roller 13 counterclockwise to convey the label paper LP in a reverse direction (−X-direction) opposite to the forward direction. The capstan roller 121, the platen roller 13, and the conveyance driving unit 17 are an example of a conveyance unit. Hereinafter, conveying the label paper LP in the forward direction is also referred to as “feed”. Further, conveying the label paper LP in the reverse direction is also called “backfeed”.

The printing unit 14 is an example of a printing unit. The printing unit 14 includes a printing head 141 and performs printing of a character, an image, and the like on the front surface of the label paper LP pinched between the platen roller 13 and the printing unit 14 (printing head 141). The printing head 141 is a thermal head having a structure in which a plurality of heating elements are aligned. The printing head 141 performs printing on the label paper LP by heating the heating elements corresponding to a printing pattern.

The printing head 141 may be configured to perform printing directly on the label paper LP by using the label paper LP as heat sensitive paper, or may be configured to perform printing on the label paper LP via an ink ribbon. In the latter case, the ink ribbon is inserted through between the platen roller 13 and the printing unit 14 (printing head 141), and the printing head 141 performs printing by transferring ink applied to the ink ribbon to the label paper LP by generating heat.

The first sensor unit 15 is provided, for example, along a conveyance path of the label paper LP between the conveyance roller 12 and the platen roller 13. The first sensor unit 15 detects the rear end (or front end) of the label area LPa from the label paper LP. Specifically, the first sensor unit 15 detects the detection mark LPb. The first sensor unit 15 can be realized by, for example, a reflective photoelectric sensor or a transmission type photoelectric sensor.

If the label paper LP is a long release paper with the sticker paper attached, the first sensor unit 15 detects a portion where a light reception level is equal to or higher than a predetermined threshold value as the rear end of the label area LPa (label).

A control unit 100 of the label printer 1, which will be described later, performs conveyance control for positioning the front end of the label area LPa at a printing position of the printing unit 14, based on the position of the label area LPa detected by the first sensor unit 15. The control unit 100 performs conveyance control for positioning the rear end of the label area LPa at a cutting position of a paper cutting unit 21, which will be described later, and conveyance control for conveying the label area LPa to a writing position of a wireless tag writing unit 22.

In the printer unit 10 configured as described above, the label paper LP on which printing is performed by the printing unit 14 is conveyed by the conveyance roller 12 and the platen roller 13, and is discharged from the discharge port 16 provided in the housing 11.

Meanwhile, the post-processing unit 20 is connected to the discharge port 16 of the printer unit 10. That is, the post-processing unit 20 is disposed at a rear stage of the printing unit 14. The post-processing unit 20 includes the paper cutting unit 21 and the wireless tag writing unit 22. Here, in the conveyance path in the forward direction, the paper cutting unit 21 is disposed on the upstream side, and the wireless tag writing unit 22 is disposed on the downstream side.

The paper cutting unit 21 is an example of a cutting unit. The paper cutting unit 21 includes a communication path 211 communicating with the discharge port 16 through which the label paper LP discharged from the discharge port 16 can pass. The lower surface of the communication path 211 has the same height as the discharge port 16, and supports the label paper LP inserted into the communication path 211 from below.

The paper cutting unit 21 also includes a cutting mechanism 212 that cuts the label paper LP inserted into the communication path 211. The cutting mechanism 212 includes, for example, a lower cutter CD provided below the communication path 211 and an upper cutter CU provided above the communication path 211, and a cutter driving unit 213 (see FIG. 3). Under the control of a CPU 101 (see FIG. 3), which will be described later, the cutter driving unit moves the upper cutter CU, which is a movable blade, downward to cut the label paper LP pinched between the lower cutter CD, which is a fixed blade, and the upper cutter CU.

The wireless tag writing unit 22 has a flat upper surface (hereinafter also referred to as a placement surface) 221 formed at the same height as the lower surface of the communication path 211. The label paper LP passed through the communication path 211 is conveyed to the placement surface 221. That is, the placement surface 221 can support the label paper LP from below while the front end of the label paper LP is exposed.

Below the placement surface 221, a reader and writer unit 222 and a second sensor unit 223 are provided. The reader and writer unit 222 is an example of a writing unit. The reader and writer unit 222 is a reader and writer device capable of performing writing and reading to and from the wireless tag. The reader and writer unit 222 includes an antenna (not illustrated) that emits radio waves above the placement surface 221, and performs writing of data on the wireless tag by transmitting data to be written via the antenna. The reader and writer unit 222 performs reading of data from the wireless tag by acquiring radio waves emitted by the wireless tag via the antenna.

The second sensor unit 223 is an example of a detection unit. The second sensor unit 223 is a sensor device that detects whether or not the label paper LP is present on the placement surface 221. For example, the second sensor unit 223 detects whether or not the label area LPa, on which printing by the printing unit 14 and writing of data by the reader and writer unit 222 are performed and which is cut by the paper cutting unit 21, is present on the placement surface 221. The second sensor unit 223 can be realized by, for example, a reflective photoelectric sensor. It is assumed that the placement surface 221 is provided with a portion through which light emitted from the second sensor unit 223 is transmitted, or a hole part through which the light emitted from the second sensor unit 223 is passed.

In the post-processing unit 20 configured as described above, the label paper LP discharged (conveyed) from the discharge port 16 of the printer unit 10 is sent to the post-processing unit 20 through the communication path 211. In the post-processing unit 20, under the control of the CPU 101 (see FIG. 3), which will be described later, cutting of the label area LPa positioned at the front end of the label paper LP or writing of data to the label area LPa are performed by operating the cutting mechanism 212 or operating the reader and writer unit 222.

In the post-processing unit 20, a length from the lower cutter CD to an end portion of the wireless tag writing unit 22 in the paper conveyance direction (X-direction) is preferably set to the extent that a length in the width direction (X-direction) of one label area LPa is confined in the length. FIG. 1 illustrates an example in which the reader and writer unit 222 is disposed on the upstream side and the second sensor unit 223 is disposed on the downstream side in the conveyance path in the forward direction, but is not limited thereto. For example, the second sensor unit 223 may be disposed on the upstream side of the reader and writer unit 222 or may be disposed in parallel with the reader and writer unit 222.

Next, a hardware configuration of the label printer 1 will be described with reference to FIG. 3. FIG. 3 is a diagram illustrating an example of the hardware configuration of the label printer 1.

As illustrated in FIG. 3, the label printer 1 includes the central processing unit (CPU) 101, a read only memory (ROM) 102, and a random access memory (RAM) 103.

The CPU 101 is an example of a processor, and is a control entity of the label printer 1. The ROM 102 stores various programs. The RAM 103 loads a program and various data. The CPU 101, the ROM 102, and the RAM 103 are connected to each other via a bus or the like. The CPU 101, the ROM 102, and the RAM 103 form a control unit 100 in a configuration of a computer. That is, the control unit 100 executes control processing related to the operation of the label printer 1 by the CPU 101 operating according to a control program 1041 stored in the ROM 102 or the storage unit 104 described later and loaded in the RAM 103.

The storage unit 104 is configured with a non-volatile memory such as a hard disc drive (HDD) or a flash memory that holds stored information even when the power is turned off. The storage unit 104 stores a control program 1041 for controlling the operation of the label printer 1. The storage unit 104 stores various setting information related to the operation of the label printer 1.

An I/O controller 105 that controls input and output of data is connected to the control unit 100 via the bus or the like. In addition to the printing unit 14, the first sensor unit 15, the reader and writer unit 222, and the second sensor unit 223 described above, the conveyance driving unit 17 and the cutter driving unit 213 are connected to the I/O controller 105. The I/O controller 105 controls I/O between various devices connected to its own I/O controller 105 and the CPU 101.

The conveyance driving unit 17 is a drive source that drives the conveyance roller 12 and the platen roller 13. The conveyance driving unit 17 includes, for example, a stepping motor. Under the control of the control unit 100, the conveyance driving unit 17 performs feed and backfeed of the label paper LP by rotationally driving the conveyance roller 12 and the platen roller 13.

The cutter driving unit 213 is a driving source that drives a cutting mechanism 212. The cutter driving unit 213 includes, for example, a stepping motor, a cam mechanism, and the like. Under the control of the CPU 101, the cutter driving unit 213 cuts the label paper LP by vertically moving the upper cutter CU.

The control unit 100 is connected to the communication unit 106 via the bus or the like. The communication unit 106 is a wired or wireless communication interface, and communicates with an external device (not illustrated) such as an information processing device. For example, the communication unit 106 receives data for printing on the label area LPa and data for writing to the wireless tag LPc from the external device. The communication unit 106 also receives an issuance instruction of the label and a stop instruction from the external device.

In the label printer 1 configured as described above, the CPU 101 controls the conveyance driving unit 17, the printing unit 14, the cutter driving unit 213 and the reader and writer unit 222. Specifically, the CPU 101 issues the label area Lpa, which is obtained by performing printing by the printing unit 14 and writing of data by the reader and writer unit 222 while conveying the label paper LP between the printing unit 14 and the reader and writer unit 222, and being cut from the label paper LP by driving the cutter driving unit 213, as one label.

The hardware configuration of the label printer 1 is not limited to the example in FIG. 3. For example, the label printer 1 may include an operation unit for receiving operation from a user, a display unit for displaying various information, and the like.

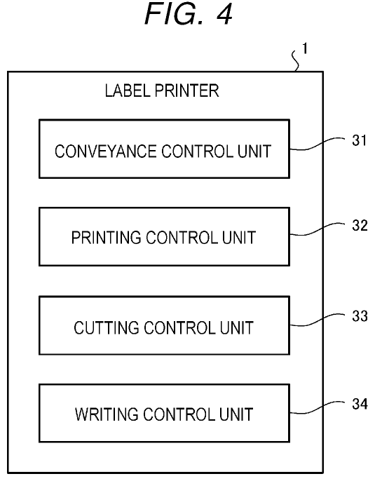

Next, a functional configuration of the label printer 1 will be described. FIG. 4 is a diagram illustrating an example of the functional configuration of the label printer 1. As illustrated in FIG. 4, the label printer 1 includes a conveyance control unit 31, a printing control unit 32, a cutting control unit 33, and a writing control unit 34.

A part or all of the functional configuration provided in the label printer 1 may be a software configuration realized by the cooperation of the processor (for example, CPU 101) of the label printer 1 and the program (for example, control program 1041) stored in the memory (for example, storage unit 104). The part or all of the functional configuration provided in the label printer 1 may be a hardware configuration realized by a dedicated circuit or the like mounted on the label printer 1.

The conveyance control unit 31 controls the conveyance of the label paper LP by controlling driving of the conveyance driving unit 17. Specifically, the conveyance control unit 31 acquires detection results of the first sensor unit 15 and the second sensor unit 223, and causes the label paper LP to be fed or backfed based on the acquired detection results. The conveyance control unit 31 controls a conveyance amount of the label paper LP and a position thereof on the conveyance path based on the position of the label area LPa detected by the first sensor unit 15.

For example, the conveyance control unit 31 positions a front end side of the label area LPa at the printing position of the printing unit 14. For example, the conveyance control unit 31 positions a rear end side of the label area LPa at the cutting position of the paper cutting unit 21. Further, for example, the conveyance control unit 31 positions the label area LPa at the writing position of the wireless tag writing unit 22. Here, the front end side and the rear end side of the label area LPa mean the front end side and the rear end side of the label area LPa positioned at the end portion of the label paper LP. In the case of FIG. 1, the +X-direction corresponds to the front end side, and the −X-direction corresponds to the rear end side.

The printing position of the printing unit 14 corresponds to a pinching position between the platen roller 13 and the printing unit 14 (printing head 141) in the conveyance path of the label paper LP. Even when the front end part of the label area LPa is positioned at the printing position, it is assumed that the conveyance amount during backfeed is predetermined so that the front end of the label area LPa does not reach the upstream side (−X-direction) of the pinching position. The cutting position of the paper cutting unit 21 corresponds to an intersection point position of the lower cutter CD and the upper cutter CU in the conveyance path of the label paper LP. The writing position of the wireless tag writing unit 22 corresponds to a position on the placement surface 221 where radio waves from the reader and writer unit 222 reach in the conveyance path of the label paper LP.

The printing control unit 32 controls the printing unit 14 to cause a character and image to be printed on the label area LPa positioned at the front end of the label paper LP. Specifically, the printing control unit 32 cooperates with the conveyance control unit 31 to heat the heating elements of the printing head 141 corresponding to the print pattern of data for printing in synchronization with the conveyance of the label paper LP to cause the character and image based on the data for printing to be printed on the front surface of the label area LPa positioned at the front end of the label paper LP.

The cutting control unit 33 controls the cutter driving unit 213 of the paper cutting unit 21 to cut the label area LPa of the label paper LP for which printing is completed. Specifically, the cutting control unit 33 drives the cutter driving unit 213 to move the upper cutter CU downward, to cause the printed label area LPa for which printing is completed to be cut from the label paper LP.

The writing control unit 34 controls the reader and writer unit 222 of the wireless tag writing unit 22 to perform writing of data on the wireless tag LPc in the label area LPa positioned at the front end of the label paper LP. Specifically, the writing control unit 34 causes the antenna of the wireless tag writing unit 22 to transmit radio waves for writing data to allow writing of write data to be performed on the wireless tag LPc provided in the label area LPa.

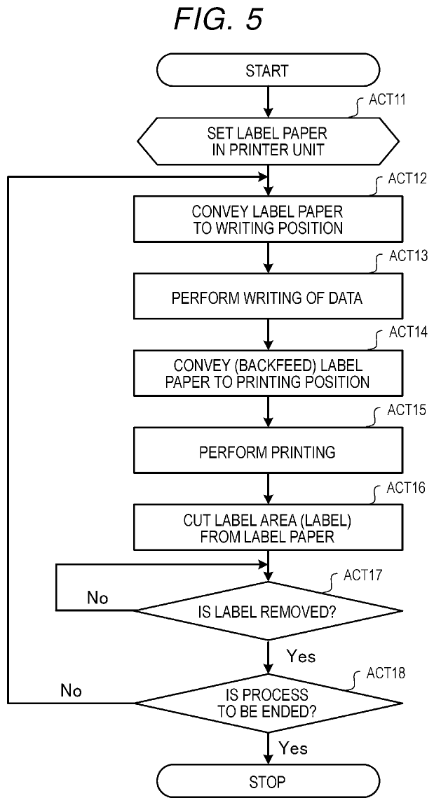

Next, a label issuance operation of the label printer 1 will be described with reference to FIGS. 5 to 10. Here, FIG. 5 is a flow chart illustrating an example of a label issuance process executed by the label printer 1 of this embodiment. Hereinafter, an execution entity of various kinds of processing included in the label issuance process will be described using the functional configuration described with reference to FIG. 4. The execution entity can be replaced with the CPU 101 or the control unit 100.

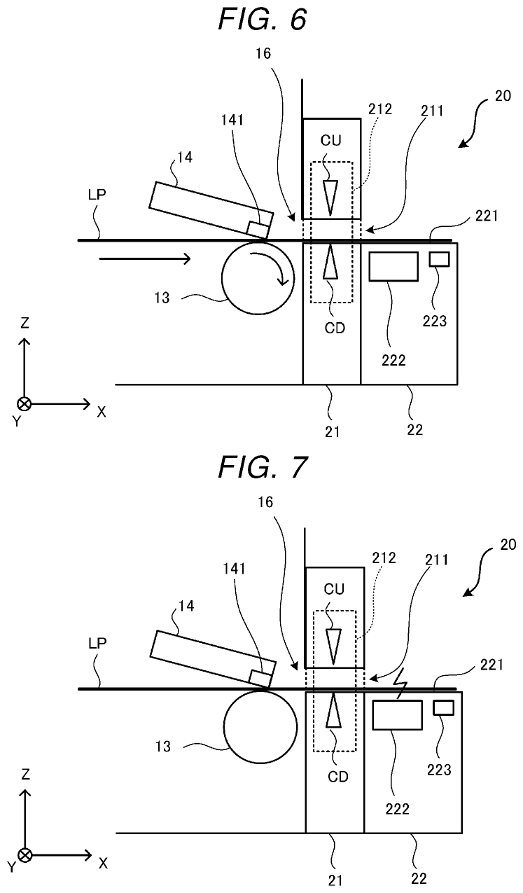

FIGS. 6 to 10 are diagrams for describing the label issuance operation of the label printer 1. In FIGS. 6 to 10, illustration of the label roll LR, the conveyance roller 12, and the first sensor unit 15 is omitted for convenience of explanation.

First, in the label printer 1, the label paper LP is assumed to be set in the printer unit 10 (Act 11). In this state, for example, if label issuance is instructed via the communication unit 106, an operation unit (not illustrated), and the like, the conveyance control unit 31 causes the label paper LP to be fed to the writing position of the wireless tag writing unit 22. (Act 12). The conveyance control unit 31 may use the detection result of the second sensor unit 223 to determine whether or not the writing position is reached.

FIG. 6 is a diagram schematically illustrating the operation of the label printer 1 performed in Act 12. As illustrated in FIG. 6, in Act 12, the conveyance control unit 31 allows the label area LPa positioned at the front end part of the label paper LP to be positioned at the writing position of the wireless tag writing unit 22. At this stage, printing on the label area LPa is incomplete.

Subsequently, the writing control unit 34 controls the reader and writer unit 222 to perform writing of the write data on the wireless tag LPc of the label area LPa positioned on the placement surface 221 (Act 13).

FIG. 7 is a diagram schematically illustrating the operation of the label printer 1 performed in Act 13. As illustrated in FIG. 7, in Act 13, the writing control unit 34 causes the antenna (not illustrated) of the reader and writer unit 222 to emit radio waves for writing to allow writing of data to be performed on the wireless tag LPc of the label area LPa positioned on the placement surface 221.

If the writing to the wireless tag LPc is completed, the conveyance control unit 31 allows the label paper LP to be backfed to the printing position of the printing unit 14 (Act 14).

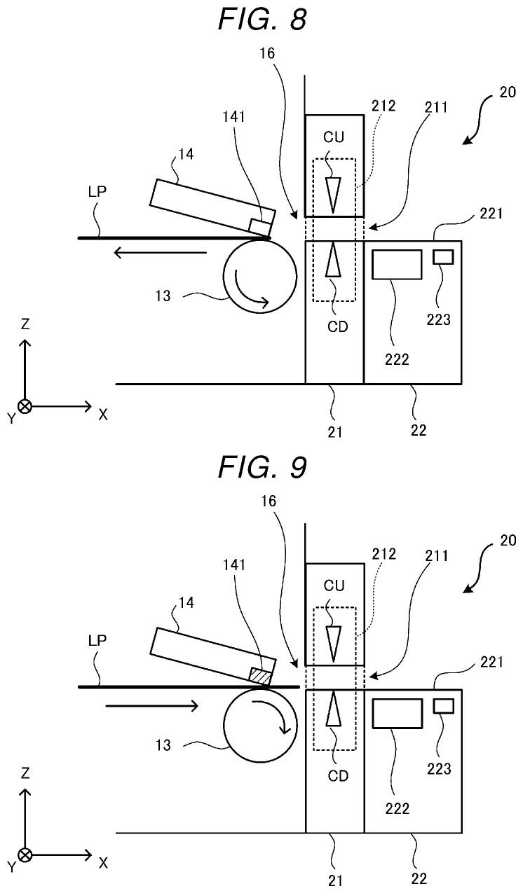

FIG. 8 is a diagram schematically illustrating the operation of the label printer 1 performed in Act 14. As illustrated in FIG. 8, in Act 14, the conveyance control unit 31 allows the label paper LP to be backfed, and allows the front end of the label paper LP to be positioned at the pinching position between the platen roller 13 and the printing unit 14.

Subsequently, the printing control unit 32 controls the printing unit 14 to start printing on the label paper LP (Act 15).

FIG. 9 is a diagram schematically illustrating the operation of the label printer 1 performed in Act 15. As illustrated in FIG. 9, in Act 15, the printing control unit 32 causes the printing head 141 to be heated to allow printing to be performed on the label area LPa of the label paper LP conveyed in the forward direction.

If printing by the printing head 141 is completed and the label area LPa reaches the cutting position of the paper cutting unit 21, the conveyance control unit 31 allows conveying the label area LPa to be stopped. Next, the cutting control unit 33 controls the cutter driving unit 213 to cut the label area LPa for which printing is completed from the label paper LP (Act 16).

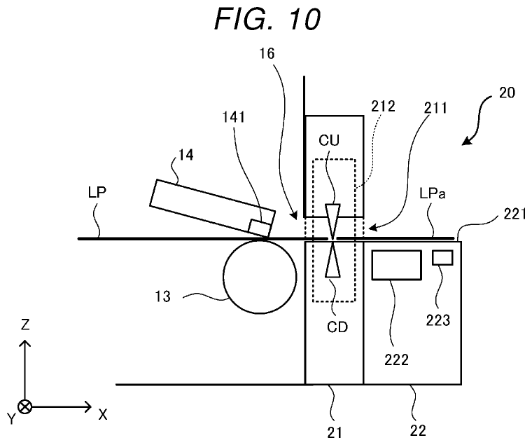

FIG. 10 is a diagram schematically illustrating the operation of the label printer 1 performed in Act 16. As illustrated in FIG. 10, in Act 16, the cutting control unit 33 controls the cutter driving unit 213 to cause the upper cutter CU to be moved downward, thereby allowing the label area LPa for which printing is completed to be cut from the label paper LP. With this configuration, the label area LPa cut from the label paper LP is issued on the placement surface 221 as one label.

Subsequently, the conveyance control unit 31 waits until the label is removed from the placement surface 221 based on the detection result of the second sensor unit (No in Act 17). If label is removed from the placement surface 221 (Yes in Act 17), the conveyance control unit 31 determines whether or not to end the process (Act 18). For example, if the number of labels to be issued is instructed via an operation unit or the like, the conveyance control unit 31 determines to end the process on the condition that the instructed number of labels are issued.

Here, if the conveyance control unit 31 determines not to end the process (No in Act 18), the process returns to Act 12. If the conveyance control unit 31 determines to end the process (Yes in Act 18), the process is ended.

As described above, the label printer 1 includes the conveyance roller 12 that conveys long label paper LP in which a plurality of label areas LPa each of which corresponds to one label and are disposed in one direction, and the wireless tag LPc is attached to each of the label areas LPa, the platen roller 13 and the conveyance driving unit 17, the printing unit 14 that performs printing on the label paper LP, the paper cutting unit 21 that is disposed at the rear stage of the printing unit 14 and cuts the label paper LP, the reader and writer unit 222 that is disposed at a rear stage of the paper cutting unit 21 and performs writing of data on the wireless tag LPc, and the processor (for example, CPU 101). The processor controls the respective units, allows printing by the printing unit 14 and writing of data by the reader and writer unit 222 to be performed on the label area LPa positioned at the front end of the label paper LP while conveying the label paper LP between the printing unit 14 and the reader and writer unit 222 and allows the label area LPa to be cut by the paper cutting unit 21, thereby allowing the label area LPa to be issued as one label.

The processor of the label printer 1 allows the label paper LP to be conveyed to the reader and writer unit 222, allows writing of data to be performed by the reader and writer unit 222, then allows the label paper LP to be conveyed in the reverse direction to the printing unit 14, and allows printing to be performed by the printing unit 14, and then allows the label area LPa on which printing is performed to be cut by the paper cutting unit 21, thereby allowing the label to be issued.

With this configuration, in the label printer 1, the label paper LP is not backfed to a position beyond the printing unit 14, and thus the front end part of the label paper LP can be prevented from being deviated from the conveyance path, and the label can be issued while the conveyance path of the label paper LP is maintained. Therefore, the label printer 1 can efficiently issue the label on which printing and writing of data are performed.

The embodiment described above can be appropriately modified and embodied by changing a part of the configuration or functions of the label printer 1. Therefore, hereinafter, some modifications of the embodiment described above will be described as other embodiments. Hereinafter, points different from the embodiment described above will be mainly described, and the detailed description of points common to the contents already described will be omitted. The modifications described below may be embodied individually or may be embodied in combination as appropriate.

### (Modification 1)

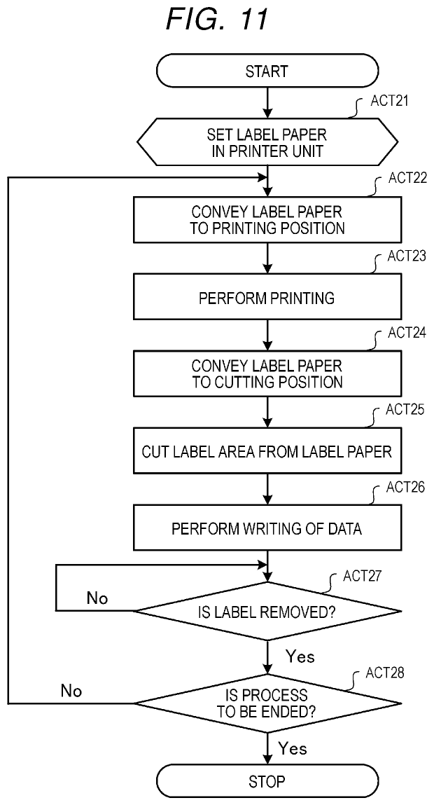

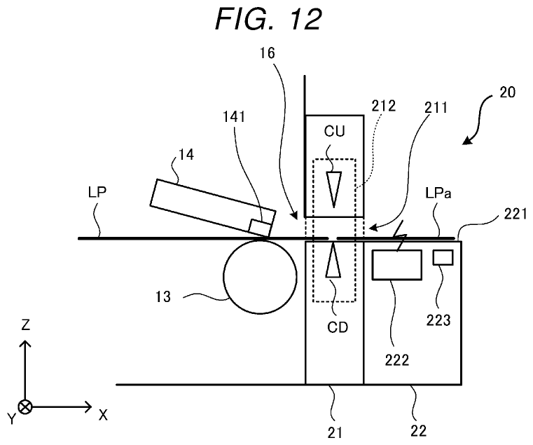

In the embodiment described above, the label printer 1 has a configuration in which writing to the wireless tag LPc is performed before printing on the label paper LP (label area LPa) is performed. However, an operation pertaining to label issuance of the label printer 1 is not limited thereto. Therefore, in this modification, another example of the label issuance operation performed by the label printer 1 will be described with reference to FIGS. 11 and 12.

FIG. 11 is a flow chart illustrating an example of the label issuance process executed by the label printer 1 of this modification. Hereinafter, the execution entity of various kinds of processing included in the label issuance process will be described using the functional configuration described with reference to FIG. 4. The execution entity can be replaced with the CPU 101 or the control unit 100.

FIG. 12 is a diagram for describing the label issuance operation of the label printer 1 according to this modification. In FIG. 12, illustration of the label roll LR, the conveyance roller 12, and the first sensor unit 15 is omitted for convenience of explanation.

First, in the label printer 1, the label paper LP is assumed to be set in the printer unit 10 (Act 21). In this state, for example, if label issuance is instructed via the communication unit 106, an operation unit (not illustrated), and the like, the conveyance control unit 31 allows the label paper LP to be conveyed until the front end of the label paper LP reaches the printing position of the printing unit 14 (Act 22).

Here, the conveyance direction of the label paper LP depends on a place where the front end of the label paper LP was finally positioned if the previous label was issued. For example, if the front end of the label paper LP is at the cutting position of the paper cutting unit 21, the conveyance control unit 31 allows backfeed to be performed until the front end of the label paper LP reaches the printing position of the printing unit 14. If the front end of the label paper LP was returned to the printing position of the printing unit 14 when issuing the previous label, the conveyance control unit 31 allows the position of the label paper LP to be maintained as it is.

Subsequently, the printing control unit 32 controls the printing unit 14 to perform printing on the label area LPa at the front end part of the label paper LP (Act 23). Here, the operating state of the label printer 1 in Act 23 is the same as the operating state illustrated in FIG. 9.

Subsequently, the conveyance control unit 31 allows the label paper LP to be conveyed to the cutting position of the paper cutting unit 21 (Act 24). Next, the cutting control unit 33 controls the cutter driving unit 213 to cut the label area LPa for which printing is completed from the label paper LP (Act 25). Here, the operating states of the label printer 1 in Acts 24 and 25 are the same as the operating states illustrated in FIGS. 6 and 10.

Subsequently, the writing control unit 34 controls the reader and writer unit 222 to perform writing of data on the wireless tag LPc of the label area LPa placed on the placement surface 221 along with the cutting (Act 26).

Here, FIG. 12 is a diagram schematically illustrating the operating state of the label printer 1 in Act 26. As illustrated in FIG. 12, in Act 26, the writing control unit 34 allows the label area LPa cut from the label paper LP to be irradiated with radio waves for writing from the antenna (not illustrated) of the reader and writer unit 222. The label area LPa in which data are written is issued as one label.

The processing of subsequent Acts 27 and 28 is the same as Acts 17 and 18 in FIG. 5 described above, and thus description thereof will be omitted.

As described above, in the label printer 1 according to this modification, the same effect as the embodiment described above can be achieved.

In the label printer 1 according to this modification, the processor allows the label paper LP to be conveyed to the printing unit 14, allows the printing to be performed by the printing unit 14, and then allows the label area LPa on which the printing is performed to be cut by the cutting unit 21. Then, the processor allows writing of data to be performed on the wireless tag LPc of the cut label area LPa in the reader and writer unit 222 to allow one label to be issued.

With this configuration, in the label printer 1 of this modification, since the label paper LP does not need to be backfed up to the printing position of the printing unit 14 after writing to the wireless tag LPc is performed, the label can be issued more efficiently compared with the operation method of the embodiment described above.

### (Modification 2)

In this modification, another example of the label issuance operation performed by the label printer 1, which is different from the embodiment and Modification 1 described above, will be described.

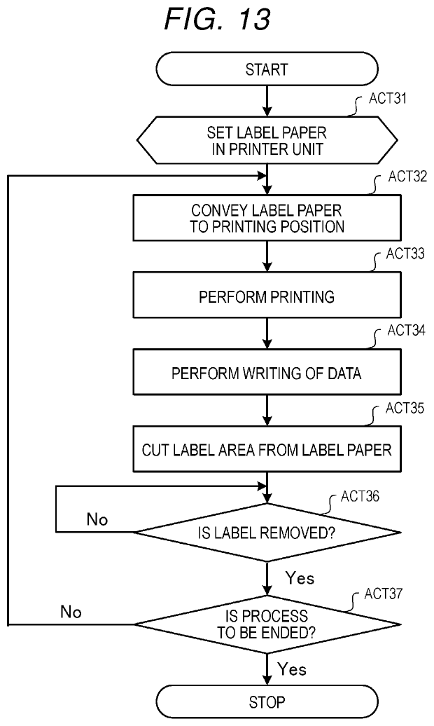

FIG. 13 is a flow chart illustrating an example of a label issuance process executed by the label printer 1 of this modification. Hereinafter, the execution entity of various kinds of processing included in the label issuance process will be described using the functional configuration described with reference to FIG. 4. The execution entity can be replaced with the CPU 101 or the control unit 100.

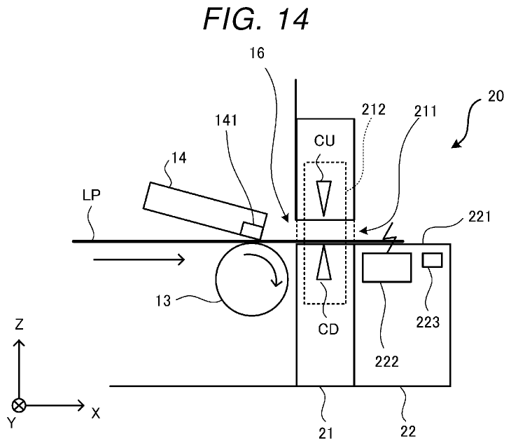

FIG. 14 is a diagram for describing the label issuance operation of the label printer 1 according to this modification. In FIG. 14, illustration of the label roll LR, the conveyance roller 12, and the first sensor unit 15 is omitted for convenience of explanation.

Acts 31 and 32 in FIG. 13 are the same as Acts 21 to 23 in FIG. 11 described above, and thus description thereof is omitted.

In Act 33, if printing is started by the printing control unit 32, the conveyance control unit 31 allows the conveyance in the forward direction that is being performed during printing to continue, and allows the label paper LP to be conveyed toward the writing position of the wireless tag writing unit 22. The writing control unit 34 controls the reader and writer unit 222 to perform writing of data to the wireless tag LPc while the conveyance control unit 31 allows the label paper LP to be conveyed toward the writing position (Act 34). That is, in Act 34, the conveyance control unit 31 and the writing control unit 34 cooperate to allow writing of data to the wireless tag LPc to be performed during conveyance to the writing position.

Here, FIG. 14 is a diagram schematically illustrating the operating state of the label printer 1 in Act 34. As illustrated in FIG. 14, in Act 34, the conveyance control unit 31 and the writing control unit 34 cooperate to allow conveyance of the wireless tag writing unit 22 toward the writing position and writing of write data by the reader and writer unit 222 to be performed in parallel.

Next, the cutting control unit 33 controls the cutter driving unit 213 to cut the label area LPa on which printing and writing of data are performed from the label paper LP (Act 35). With this configuration, one label for which the printing of data for printing and the writing of write data are completed is issued on the placement surface 221.

The processing of the subsequent Acts 36 and 37 is the same as Acts 17 and 18 in FIG. 5 described above, and thus description thereof is omitted.

As described above, in the label printer 1 according to this modification, the same effect as the embodiment described above can be achieved.

In the label printer 1 according to this modification, if the printing unit 14 performs printing, the processor allows the reader/writer unit 222 to perform writing of data while allowing the printing to be performed by allowing the label paper LP to be conveyed toward the wireless tag writing unit 22. Then, the processor allows the label area LPa for which printing by the printing unit 14 and writing of data by the reader and writer unit 222 are completed to be cut by the paper cutting unit 21, and allows one label to be issued.

With this configuration, in the label printer 1 of this modification, since writing of data can be performed while performing printing, the label can be issued more efficiently than the operation method of the embodiment described above in which conveyance is stopped for writing data.

In the label printer 1 according to this modification, after writing to the wireless tag LPc, the label paper LP does not need to be backfed to the printing position of the printing unit 14, and thus the label can be issued more efficiently than the operation example of the embodiment described above. Furthermore, in the label printer 1 according to this modification, if the label paper LP is conveyed to the writing position of the wireless tag writing unit 22, writing to the wireless tag LPc can be performed at the same time, and thus the time needed for issuing one label can be speeded up.

### (Modification 3)

In the embodiment described above, the label printer 1 is configured to include the single processor (CPU 101), but the label printer 1 is not limited to the configuration. For example, each of the printer unit 10 and post-processing unit 20 may include an independent processor. In this case, a device related to the printer unit 10 is connected to the processor of the printer unit 10, and a device related to the post-processing unit 20 is connected to the processor of the post-processing unit 20. The processor of the printer unit 10 and the processor of the post-processing unit 20 are communicably connected via a bus or the like, and both processors cooperate to control the operation of the label printer 1. In this case, for example, the conveyance control unit 31 and the printing control unit 32 may be realized by the processor of the printer unit 10, and the cutting control unit 33 and the writing control unit 34 may be realized by the processor of the post-processing unit 20.

Each of the paper cutting unit 21 and the wireless tag writing unit 22 may be provided with an independent processor. In this case, a device related to the paper cutting unit 21 is connected to the processor of the paper cutting unit 21, and a device related to the wireless tag writing unit 22 is connected to the processor of the wireless tag writing unit 22. Also in this case, the processor of the printer unit 10 and the processors of the paper cutting unit 21 and the wireless tag writing unit 22 are connected via the bus or the like so as to be able to communicate with each other, and the respective processors cooperate to control the operation of the label printer 1. In this case, for example, the cutting control unit 33 may be realized by the processor of the paper cutting unit 21, and the writing control unit 34 may be realized by the processor of the wireless tag writing unit 22.

The program executed in the label printer 1 of the embodiment described above is provided in a state of being incorporated beforehand in a ROM, a storage unit, or the like. A configuration may be adopted in which the program executed in the label printer 1 of the embodiment described above is provided by being recorded in a computer-readable recording medium such as a CD-ROM, a flexible disk (FD), a CD-R, or a digital versatile disk (DVD) as a file in an installable format or executable format.

Furthermore, a configuration may be adopted in which the program executed in the label printer 1 of the embodiment described above is stored on a computer connected to a network such as the Internet, and is provided by being downloaded via the network. A configuration may be adopted in which the program executed in the label printer 1 of the embodiment described above may be provided or distributed via the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer device, comprising:
a conveyance component configured to convey long label paper having a plurality of label areas, each of which corresponds to one label, disposed in one direction and a wireless tag attached to each of the label areas;
a printing component configured to perform printing on the long label paper;
a cutting component disposed at a rear stage of the printing component and configured to cut the long label paper;
a writing component disposed at a rear stage of the cutting component and configured to perform writing of data on the wireless tag; and
a processor configured to
allow printing by the printing component to be performed and writing of data by the writing component to be performed on the label area positioned at a front end of the long label paper while controlling the conveyance component to convey the long label paper between the printing component and the writing component and allow the label area to be cut by the cutting component, thereby issuing a label, and
allow the long label paper to be conveyed to the printing component,
after performing printing by the printing component, allow the label area on which the printing is performed to be cut by the cutting component, and
allow writing of data on the wireless tag of the cut label area to be performed by the writing component.

2. The printer device according to claim 1, further comprising:
a detector configured to detect the presence or absence of an issued label, wherein
the processor is further configured to, if determined that the issued label is removed based on a detection result of the detector, perform a process of issuing another label for a next label area positioned at the front end of the long label paper.

3. The printer device according to claim 2, wherein
the detector is provided at a rear stage of the writing component or between the cutting component and the writing component.

4. The printer device according to claim 1, wherein
the conveyance component is further configured to convey the long label paper in a forward feed direction and a backward backfeed direction.

5. A printing method, comprising:
conveying long label paper having a plurality of label areas, each of which corresponds to one label, disposed in one direction and a wireless tag attached to each of the label areas;
printing on the long label paper;
cutting the long label paper with a cutting component disposed at a rear stage of a printing component;
writing data on the wireless tag with a writing component disposed at a rear stage of the cutting component;
allowing printing by the printing component to be performed and writing of data by the writing component to be performed on the label area positioned at a front end of the long label paper while controlling the conveying of the long label paper between the printing component and the writing component and allowing the label area to be cut by the cutting component, thereby issuing a label;
allowing the long label paper to be conveyed to the printing component;
after printing by the printing component, allowing the label area on which the printing is performed to be cut by the cutting component; and
allowing writing of data on the wireless tag of the cut label area to be performed.

6. The printing method according to claim 5, further comprising:
detecting the presence or absence of an issued label; and
if determined that the issued label is removed based on a detection result, issuing another label for a next label area positioned at the front end of the long label paper.

7. The printing method according to claim 6, wherein
the detector is provided at a rear stage of the writing component or between the cutting component and the writing component.

8. A thermal printer, comprising:
a conveyance component configured to convey long label paper having a plurality of label areas, each of which corresponds to one label, disposed in one direction and a wireless tag attached to each of the label areas;
a thermal printing head configured to perform printing on the long label paper;
a cutting component disposed at a rear stage of the thermal printing head and configured to cut the long label paper;
a writing component disposed at a rear stage of the cutting component and configured to perform writing of data on the wireless tag; and
a processor configured to
allow printing by the printing head to be performed and writing of data by the writing component to be performed on the label area positioned at a front end of the long label paper while controlling the conveyance component to convey the long label paper between the thermal printing head and the writing component and allow the label area to be cut by the cutting component, thereby issuing a label, and
allow the long label paper to be conveyed to the thermal printing head,
after performing printing by the thermal printing head, allow the label area on which the printing is performed to be cut by the cutting component, and
allow writing of data on the wireless tag of the cut label area to be performed by the writing component.

9. The thermal printer according to claim 8, further comprising:
a detector configured to detect the presence or absence of an issued label, wherein
the processor is further configured to, if determined that the issued label is removed based on a detection result of the detector, perform a process of issuing another label for a next label area positioned at the front end of the long label paper.

10. The thermal printer according to claim 9, wherein
the detector is provided at a rear stage of the writing component or between the cutting component and the writing component.

11. The thermal printer according to claim 8, wherein
the conveyance component is further configured to convey the long label paper in a forward feed direction and a backward backfeed direction.
